(19) United States
(12) Patent Application Publication
(10) Pub. No.: US 2026/0210803 A1
(43) Pub. Date: Jul. 23, 2026

(54) INSPECTION METHOD AND NON-TRANSITORY COMPUTER-READABLE MEDIUM FOR FUEL SUPPLY LINE FOR GAS TURBINE

(71) Applicant: MITSUBISHI HEAVY INDUSTRIES, LTD., Tokyo (JP)

(72) Inventors: Yoji ENDO, Tokyo (JP); Kohei HAYASHI, Tokyo (JP); Norihisa KISHI, Kanagawa (JP); Hidekazu YAMASHITA, Tokyo (JP); Yoshikazu UEKI, Tokyo (JP); Kei FURUKAWA, Tokyo (JP)

(21) Appl. No.: 19/437,785

(22) Filed: Dec. 31, 2025

(30) Foreign Application Priority Data
Jan. 20, 2025 (JP) 2025-007867

(51) Int. Cl. G01M 15/14; F02C 7/22; G01M 15/04

(52) U.S. Cl. CPC G01M 15/14; F02C 7/22; G01M 15/042; F05D 2260/83

(57) ABSTRACT

An inspection method for a fuel supply line for a gas turbine is an inspection method for inspecting an assembled state of the fuel supply line for guiding fuel to a combustor of the gas turbine, the method comprising: a purge step of, after assembly of the fuel supply line, continuously supplying a purge gas to the fuel supply line for a predetermined time so that the purge gas is discharged from an injection nozzle of the combustor.

### TECHNICAL FIELD

The present disclosure relates to an inspection method and a non-transitory computer-readable medium for a fuel supply line for a gas turbine.

The present application claims priority based on Japanese Patent Application No. 2025-007867 filed on Jan. 20, 2025, the entire content of which is incorporated herein by reference.

### BACKGROUND ART

Conventionally, an inspection method for performing a leak check of a control valve installed on a fuel supply line for a gas turbine is known. For example, in Patent Document 1, two control valves provided in a fuel flow path of a gas turbine are both set to a closed state, and a purge gas is supplied to the fuel flow path between the two control valves.

### CITATION LIST

### Patent Literature

Patent Document 1: JP4287989B

### SUMMARY

At the time of installation of a gas turbine, a fuel supply line of the gas turbine is assembled. Also, at the time of periodic inspection of the gas turbine performed after the gas turbine has operated for a certain period, at least a part of the fuel supply line is disassembled in association with replacement of the combustor, and the disassembled parts are reassembled.

At the time of assembly of the fuel supply line of the gas turbine, flanges of two pipes are joined by bolt fastening. When an assembly worker has little experience, an assembly omission where the fastening work is performed while forgetting to place a gasket between the two flanges, or a fastening failure where a fastening torque is insufficient for bolt fastening, may occur. Therefore, after completion of the assembly work, it is necessary to inspect the assembled state of the fuel supply line. It is preferable that the inspection be easily executed even by an inspector with little experience, but the above-mentioned Patent Document does not disclose a specific configuration.

An object of the present disclosure is to provide an inspection method and a non-transitory computer-readable medium for a fuel supply line for a gas turbine whereby it is possible to easily inspect the assembled state of the fuel supply line even by an inspector with little experience.

An inspection method for a fuel supply line for a gas turbine according to at least one embodiment of the present disclosure is an inspection method for a fuel supply line for a gas turbine for inspecting the assembled state of the fuel supply line for guiding fuel to a combustor of the gas turbine, the method including:
a purge step of, after assembly of the fuel supply line, continuously supplying a purge gas to the fuel supply line for a predetermined time so that the purge gas is discharged from an injection nozzle of the combustor.

A non-transitory computer-readable medium according to at least one embodiment of the present disclosure stores instructions that cause a processor of a computer device for inspecting the assembled state of a fuel supply line for guiding fuel to a combustor of a gas turbine to execute:
a purge step of, after assembly of the fuel supply line, continuously supplying a purge gas to the fuel supply line for a predetermined time so that the purge gas is discharged from an injection nozzle of the combustor.

The present disclosure provides an inspection method and a non-transitory computer-readable medium for a fuel supply line for a gas turbine whereby it is possible to easily inspect the assembled state of the fuel supply line even by an inspector with little experience.

### BRIEF DESCRIPTION OF DRAWINGS

FIG. 1 is a schematic diagram of a gas turbine according to an embodiment.

FIG. 2 is a schematic diagram of a fuel supply system and a purge gas supply system according to an embodiment.

FIG. 3 is a schematic diagram of a pipe connection part according to an embodiment.

FIG. 4 is a schematic diagram showing a purge gas supply operation according to an embodiment.

FIG. 5 is a flowchart of an inspection method for a fuel supply line for a gas turbine according to an embodiment.

FIG. 6 is a schematic diagram of a gas turbine provided with additional components according to an embodiment.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

The same configurations are indicated by the same reference signs and may not be described again in detail.

### Overview of Gas Turbine 1

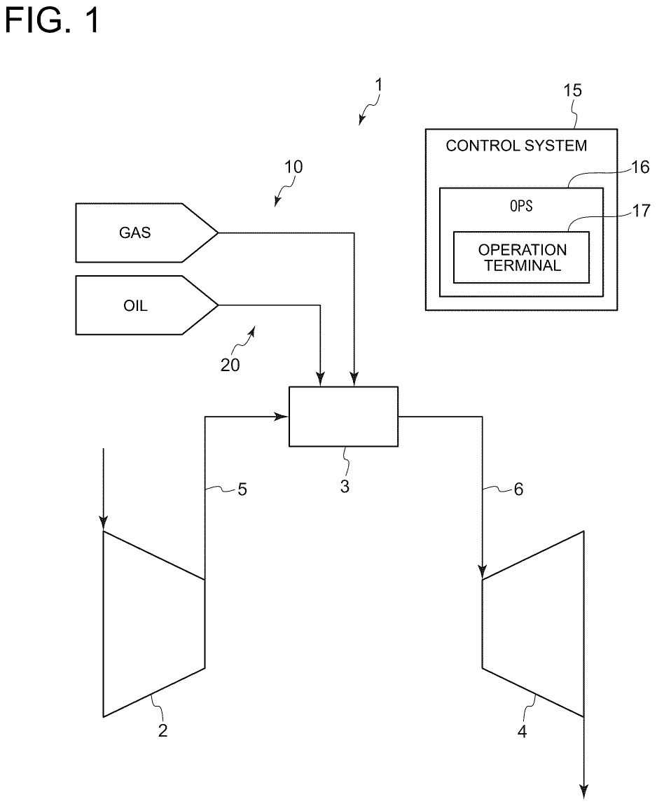

FIG. 1 is a schematic diagram of a gas turbine 1 according to an embodiment of the present disclosure. The gas turbine 1 includes a compressor 2, a compressed air supply line 5, a combustor 3, a combustion gas supply line 6, and a turbine 4. The compressor 2 is configured to generate compressed air from air. The compressed air supply line 5 is configured to guide the compressed air sent from the compressor 2 to the combustor 3. The combustor 3 includes a combustion tube that generates combustion gas by a combustion reaction between the compressed air and gas turbine fuel. The combustion gas supply line 6 is configured to guide the combustion gas discharged from the combustion tube to the turbine 4. The turbine 4 is configured to rotate a gas turbine rotor with power extracted in the process of expanding the combustion gas.

The gas turbine 1 of this example is a dual fuel type in which two types of gas turbine fuels are supplied to the combustor 3, and the gas turbine fuels include gas fuel such as natural gas and oil fuel such as heavy oil. The gas turbine 1 includes a gas fuel supply system 10 for supplying the gas fuel to the combustor 3, and an oil fuel supply system 20 for supplying the oil fuel to the combustor 3. Which of the gas fuel or the oil fuel is supplied to the combustor 3 as the gas turbine fuel differs depending on the operation state of the gas turbine 1. In the following, for convenience of explanation, the “oil fuel supply system 20” may be abbreviated as the “fuel supply system 20”.

Although only a single combustor 3 is illustrated in FIG. 1 as a schematic diagram, the actual gas turbine 1 includes a plurality of combustors 3. The configuration of each combustor 3 is exemplified in JP2013-096303A. Detailed description of the configuration is omitted herein, but the outline is as follows.

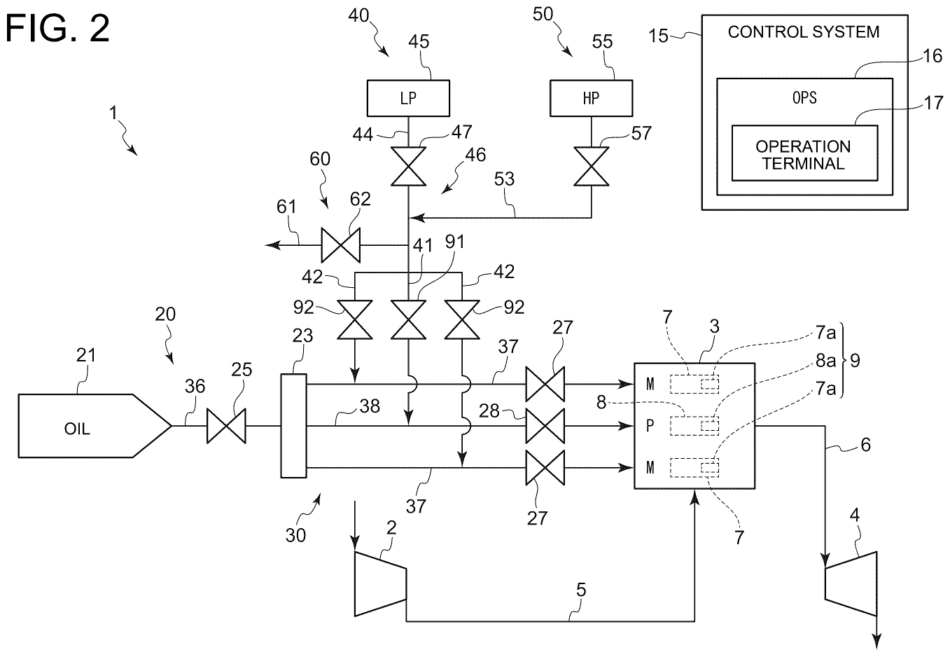

As shown in FIG. 2, the combustor 3 includes a pilot burner 8 disposed at the center position of the combustion tube, and a plurality of main burners 7 disposed at equal intervals so as to surround the pilot burner 8. The pilot burner 8 has a pilot nozzle 8a for diffusion combustion of the gas turbine fuel as pilot fuel in the combustion tube. A diffusion flame is formed by the diffusion combustion in the combustion tube. The main burner 7 has a main nozzle 7a for injecting a premixed gas consisting of the gas turbine fuel as main fuel and the compressed air as primary air into the combustion tube. The premixed gas injected into the combustion tube burns by flame transfer from the diffusion flame, whereby a premixed flame is formed. Hereinafter, the pilot nozzle 8a and the main nozzles 7a may be collectively referred to as “injection nozzle 9”.

Operation of the gas turbine 1 is controlled by a control system 15. The control system 15 includes a plurality of control panels that send control commands to various actuators constituting the gas turbine 1, such as motors, solenoids, or air cylinders. Measurement results of various measuring instruments such as thermometers, pressure gauges, or flow meters installed in the gas turbine 1 are sent to these control panels.

Further, the control system 15 includes an operation station (OPS) 16 serving as a human machine interface (HMI) that performs operation and monitoring of a plant, and an operation terminal 17 operated by an operator is installed in the operation station 16. The operation terminal 17 is electrically connected to the plurality of control panels.

The plurality of control panels and the operation terminal 17 are computer devices constituting the control system 15. The computer device includes a processor and a memory. The processor may be CPU, GPU, MPU, DSP, or a combination thereof, or may be implemented by an integrated circuit such as PLD, ASIC, FPGA, or MCU. The memory is configured to temporarily or non-temporarily store various data, and is implemented by at least one of RAM, ROM, or a flash memory, for example. The processor executes various control processes in accordance with programs loaded in the memory. The computer device corresponding to the operation terminal 17 may further include an input unit and a monitor. The processor may execute predetermined processing based on various instructions input to the input unit by the operator, and various data processed by the processor may be displayed on the monitor.

### Fuel Supply System 20

As shown in FIG. 2, the fuel supply system 20 includes a fuel supply source 21, a distributor 23, and a fuel supply line 30.

The fuel supply source 21 stores oil fuel. The distributor 23 is configured to distribute the oil fuel from the fuel supply source 21 in accordance with the injection nozzle 9 which is a supply destination. The distributor 23 may include a main system distributor for distributing the oil fuel to the plurality of main nozzles 7a, and a pilot system distributor for distributing the oil fuel to the pilot nozzle 8a.

The fuel supply line 30 includes an upstream fuel supply line 36 for guiding the oil fuel from the fuel supply source 21 to the distributor 23, a pilot fuel supply line 38 for guiding the oil fuel from the distributor 23 to the pilot nozzle 8a, and a plurality of main fuel supply lines 37 for guiding the oil fuel from the distributor 23 to the plurality of main nozzles 7a, respectively.

As described above, the actual number of combustors 3 is plural. The upstream fuel supply line 36 may be a main pipe that guides the oil fuel to the plurality of combustors 3, and the pilot fuel supply line 38 and the main fuel supply lines 37 may be branch pipes provided corresponding to each of the plurality of combustors 3.

The fuel supply system 20 further includes a fuel valve 25 disposed on the upstream fuel supply line 36, a pilot fuel valve 28 disposed on the pilot fuel supply line 38, and a plurality of main fuel valves 27 respectively disposed on the plurality of main fuel supply lines 37.

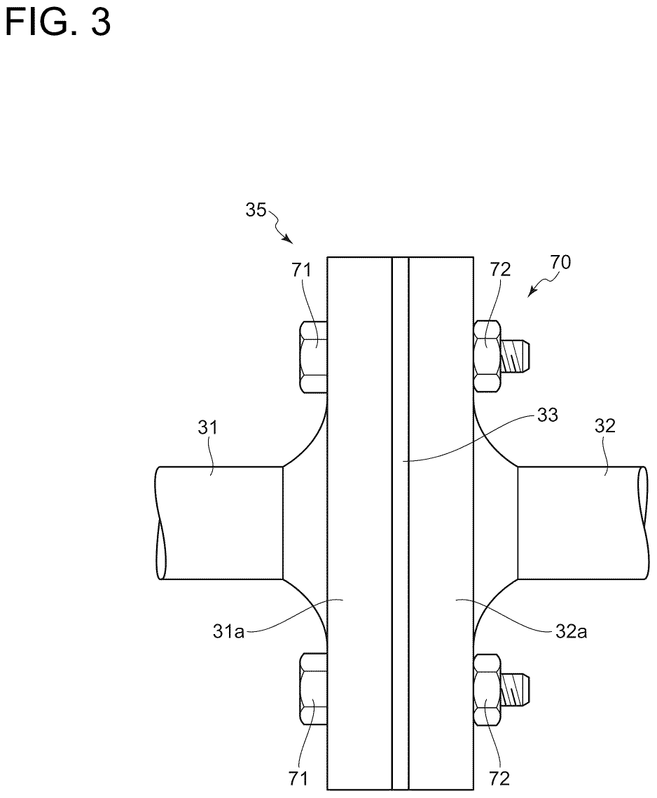

FIG. 3 is a schematic diagram illustrating a pipe connection part 35. A pipe group constituting the fuel supply line 30 includes a first pipe 31 and a second pipe 32. Both pipes are applied to each of the pilot fuel supply line 38 and the main fuel supply lines 37.

The pipe connection part 35 includes a first flange 31a formed at one end of the first pipe 31, and a second flange 32a formed at one end of the second pipe 32. The first flange 31a and the second flange 32a are connected by a pipe fastening part 70 in a state where a gasket 33 is interposed therebetween.

The pipe fastening part 70 includes a plurality of bolts 71 and a plurality of nuts 72. Each bolt 71 is inserted into a bolt hole formed in each of the first flange 31a, the gasket 33, and the second flange 32a. The plurality of nuts 72 are screwed onto the plurality of bolts 71, respectively, and are tightened with a specified fastening torque.

### Purge Gas Supply System

Returning to FIG. 2, the purge gas supply system will be described. If the oil fuel remains in the injection nozzle 9 of the combustor 3, there is a risk of coking of the injection nozzle 9. The gas turbine 1 of this example is configured to supply a low-pressure purge gas or a high-pressure purge gas at a timing when the turbine fuel injected by the injection nozzle 9 is switched from the oil fuel to the gas fuel, or at a timing when the gas turbine 1 stops operation. The low-pressure purge gas or the high-pressure purge gas injected into the combustion tube together with the oil fuel remaining in the injection nozzle 9 suppresses coking. The pressure of the low-pressure purge gas is lower than the pressure of the high-pressure purge gas. Both the low-pressure purge gas and the high-pressure purge gas in this example are compressed air, but the present disclosure is not limited thereto. At least one of the gases may be an inert gas such as nitrogen gas.

The gas turbine 1 includes a low-pressure purge gas supply system 40 and a high-pressure purge gas supply system 50. The low-pressure purge gas supply system 40 is configured to supply the low-pressure purge gas to the fuel supply line 30, and the high-pressure purge gas supply system 50 is configured to supply the high-pressure purge gas to the fuel supply line 30.

The low-pressure purge gas supply system 40 includes a low-pressure purge gas supply source 45 and a purge gas line 46. The low-pressure purge gas supply source 45 may be a tank or a compressor device.

The purge gas line 46 has an upstream purge gas line 44, a first purge gas line 41, and a plurality of second purge gas lines 42. One end of the upstream purge gas line 44 is connected to the low-pressure purge gas supply source 45, and the other end is connected to the respective upstream ends of the first purge gas line 41 and the plurality of second purge gas lines 42. The downstream end of the first purge gas line 41 is connected to the pilot fuel supply line 38, and the downstream ends of the plurality of second purge gas lines 42 are connected to the plurality of main fuel supply lines 37, respectively.

Further, a purge gas valve 47 is disposed on the upstream purge gas line 44, a first supply valve 91 is disposed on the first purge gas line 41, and a plurality of second supply valves 92 are respectively disposed on the plurality of second purge gas lines 42.

The high-pressure purge gas supply system 50 includes a high-pressure purge gas supply source 55, a high-pressure purge gas line 53, and a high-pressure purge gas valve 57. The high-pressure purge gas supply source 55 may be a compressor device or a tank. The high-pressure purge gas line 53 is connected to the high-pressure purge gas supply source 55 and the upstream purge gas line 44. The connection position between the high-pressure purge gas line 53 and the upstream purge gas line 44 is downstream of the purge gas valve 47 in the upstream purge gas line 44. The high-pressure purge gas line 53 is indirectly connected to the fuel supply line 30 via the purge gas line 46. The high-pressure purge gas valve 57 is disposed on the high-pressure purge gas line 53.

In this example, a vent system 60 is arranged so that the pressure of the fuel supply line 30 does not increase rapidly with the supply of the low-pressure purge gas or the high-pressure purge gas. The vent system 60 includes a vent line 61 connected to the upstream purge gas line 44, and a vent valve 62 disposed on the vent line 61. The connection position between the vent line 61 and the upstream purge gas line 44 is downstream of the purge gas valve 47 in the upstream purge gas line 44.

A purge operation in which the gas turbine 1 supplies the high-pressure purge gas or the low-pressure purge gas will be outlined. The purge operation is an operation for suppressing coking of the injection nozzle 9, and includes a fuel switching purge operation and a shutdown purge operation.

The fuel switching purge operation is automatically executed in response to the turbine fuel supplied to the combustor 3 switching from the oil fuel to the gas fuel. At this time, since the pressure in the combustion tube is relatively high, the high-pressure purge gas is supplied to the injection nozzle 9. Specifically, the high-pressure purge gas valve 57, the first supply valve 91, the second supply valves 92, and the vent valve 62 are set to an open state, and the purge gas valve 47 is set to a closed state. At this time, both the pilot fuel valve 28 and the main fuel valves 27 are in an open state.

The high-pressure purge gas discharged from the high-pressure purge gas supply source 55 to the high-pressure purge gas line 53 flows through the first purge gas line 41 and the second purge gas lines 42 via the upstream purge gas line 44. The high-pressure purge gas flowing through the first purge gas line 41 is supplied to the pilot nozzle 8a, and the high-pressure purge gas flowing through the second purge gas lines 42 is supplied to the main nozzles 7a, respectively. At this time, since the vent valve 62 is opened, the high-pressure purge gas does not remain in the fuel supply line 30, and the pressure of the fuel supply line 30 does not exceed an allowable range.

The shutdown purge operation is automatically executed in response to the operation state of the gas turbine 1 switching from an operating state to a stop state. At this time, since the pressure in the combustion tube is relatively low, the low-pressure purge gas is supplied to the injection nozzle 9. Specifically, the purge gas valve 47, the first supply valve 91, the second supply valves 92, and the vent valve 62 are set to an open state, and the high-pressure purge gas valve 57 is set to a closed state. At this time, both the pilot fuel valve 28 and the main fuel valves 27 are in an open state.

The low-pressure purge gas discharged from the low-pressure purge gas supply source 45 to the upstream purge gas line 44 flows through the first purge gas line 41 and the second purge gas lines 42. The low-pressure purge gas flowing through the first purge gas line 41 is supplied to the pilot nozzle 8a, and the low-pressure purge gas flowing through the second purge gas lines 42 is supplied to the main nozzles 7a, respectively. At this time, since the vent valve 62 is opened, it is possible to avoid the low-pressure purge gas remaining in the fuel supply line 30.

The uses of the low-pressure purge gas and the high-pressure purge gas are not limited to the above examples. For example, the high-pressure purge gas may be used in the shutdown purge operation.

### Assembly Inspection of Fuel Supply Line 30

The outline of an assembly inspection of the fuel supply line 30 will be described with reference to FIGS. 2 to 4. When the gas turbine 1 is newly installed, all pipes constituting the fuel supply line 30 are assembled. Also, after the gas turbine 1 has operated for more than a certain period, a periodic inspection of the gas turbine 1 is performed. At this time, at least some of all pipes constituting the fuel supply line 30 is disassembled once in association with replacement of the combustor 3, and is reassembled after installation of a new combustor 3.

In either the new installation of the gas turbine 1 or the periodic inspection of the gas turbine 1, the first pipe 31 and the second pipe 32 are fastened with the pipe fastening part 70 along with the assembly of pipes. At this time, there is a possibility that an assembly omission where an assembly worker forgets to place the gasket 33 between the first pipe 31 and the second pipe 32, or a fastening failure where the fastening torque of the nut 72 falls below a specified value, may occur. Therefore, it is necessary for an inspector to inspect whether there is an abnormality in the assembled state of the pipe fastening part 70 after completion of assembly of the fuel supply line 30 and before the start of operation of the gas turbine 1.

In the present embodiment, the low-pressure purge gas is used for inspection of the assembled state. If the low-pressure purge gas is continuously supplied to the fuel supply line 30 so that the low-pressure purge gas is discharged from the injection nozzle 9, the low-pressure purge gas leaks at the pipe fastening part 70 having an abnormality in assembly. The inspector determines that there is an abnormality in assembly in the pipe fastening part 70 where the leak is occurring.

The low-pressure purge gas used for inspection of the assembled state is not utilized for suppression of coking of the injection nozzle 9. In the following, the low-pressure purge gas used in the inspection of the assembled state of the fuel supply line 30 may be referred to as “purge gas”. Also, the pipe connection part 35 assembled in a state where the gasket 33 is missing and the pipe connection part 35 with insufficient tightening torque may be referred to as “pipe connection part 35” hereinafter without being distinguished from the pipe connection part 35 with normal assembly.

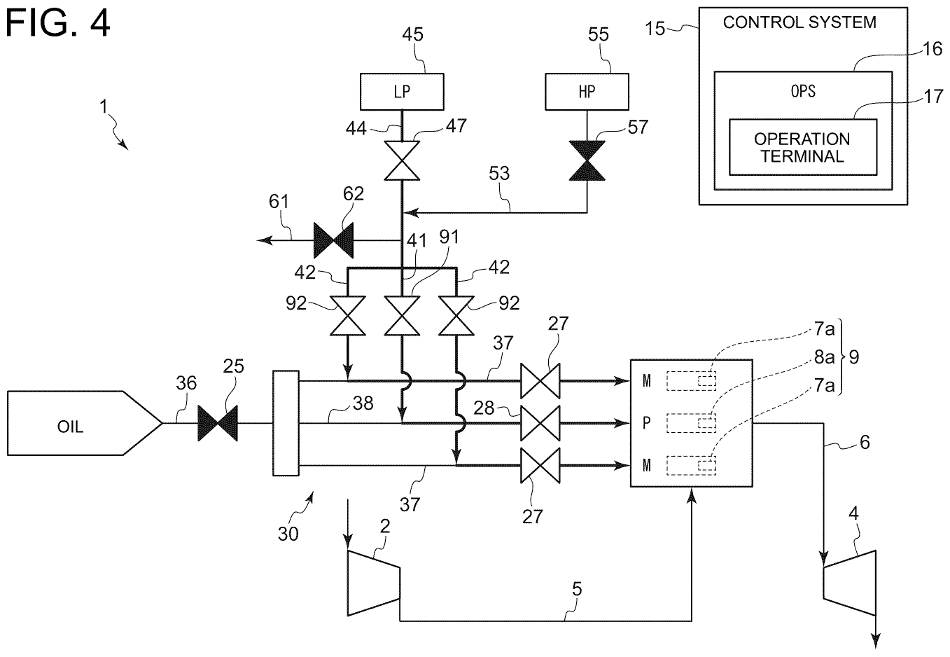

FIG. 4 is a schematic diagram showing the gas turbine 1 when the purge gas is supplied to the fuel supply line 30 for the purpose of inspection of assembly. Before the start of supply of the purge gas, the purge gas valve 47, the first supply valve 91, the second supply valves 92, the pilot fuel valve 28, and the main fuel valves 27 are in an open state. On the other hand, the high-pressure purge gas valve 57, the vent valve 62, and the fuel valve 25 are in a closed state.

The purge gas discharged from the low-pressure purge gas supply source 45 flows into the first purge gas line 41 or the second purge gas line 42. The purge gas flowing from the first purge gas line 41 into the pilot fuel supply line 38 flows toward the pilot nozzle 8a. The purge gas flowing from the second purge gas line 42 into the main fuel supply line 37 flows toward the main nozzle 7a. Among the plurality of pipe connection parts 35 constituting the pilot fuel supply line 38 or the main fuel supply line 37, the purge gas leaks at the pipe connection part 35 having an abnormality in assembly.

The above-described supply of the purge gas is automatically executed by the control system 15. As a more specific example, the purge gas is continuously supplied to the fuel supply line 30 for a predetermined time from when the operator inputs a start instruction to the operation terminal 17 until when the operator inputs an end instruction.

### Permission Condition

Before the start of supply of the purge gas, a permission condition under which the supply of the purge gas is considered to be executable normally needs to be satisfied. The permission condition may be constituted by a plurality of specific conditions, and in this case, the permission condition is satisfied when all of the constituting conditions are satisfied.

The permission condition of this example includes a gas turbine stop condition, an operation stop purge condition, a fuel valve closed condition, a vent valve closed condition, a high-pressure purge gas valve closed condition, and a valve normal condition. Only when these six conditions are satisfied, the supply of the purge gas is started.

The gas turbine stop condition is satisfied when the gas turbine 1 is in a stop state, and is not satisfied when the gas turbine 1 is in an operating state. By setting this condition, it is possible to avoid the purge gas being supplied while the gas turbine 1 is operating for startup, for example.

The operation stop purge condition is satisfied when the above-described shutdown purge operation, which is automatically executed in response to the operation state of the gas turbine 1 switching from the operating state to the stop state, is not being executed, and is not satisfied when the shutdown purge operation is being executed. By setting this condition, supply of the purge gas is not started during the shutdown purge operation of the gas turbine 1. Therefore, it is possible to avoid the purge gas flowing to an unexpected pipe different from a pipe to be inspected.

The fuel valve closed condition is satisfied when the fuel valve 25 is in a closed state, and is not satisfied when the fuel valve 25 is in an open state. By setting this condition, it is possible to avoid the purge gas being supplied while the oil fuel is supplied. Therefore, it is possible to avoid the oil fuel flowing back through the first purge gas line 41 or the second purge gas line 42 or the like.

The vent valve closed condition is satisfied when the vent valve 62 is in a closed state, and is not satisfied when the vent valve 62 is in an open state. By setting this condition, it is possible to avoid the purge gas being released to the atmosphere from the vent line 61. Therefore, it is possible to avoid the leak amount of the purge gas becoming insufficient in the pipe connection part 35 having an abnormality in assembly.

The high-pressure purge gas valve closed condition is satisfied when the high-pressure purge gas valve 57 is in a closed state, and is not satisfied when the high-pressure purge gas valve 57 is in an open state. By setting this condition, it is possible to avoid the purge gas flowing to an unexpected pipe different from the pipe to be inspected.

The valve normal condition is satisfied when both the fuel valve 25 and the purge gas valve 47 are in a normal state, and is not satisfied when at least one of the fuel valve 25 or the purge gas valve 47 is not in the normal state. The normal state refers to a state where the valve can execute a predetermined operation in accordance with a control command transmitted from the control system 15. By setting this condition, it is ensured that the fuel valve 25 and the purge gas valve 47 faithfully execute predetermined operations in accordance with the control command transmitted from the control system 15.

For example, when at least one of the fuel valve 25 or the purge gas valve 47 is operated by an air cylinder, if the pressure value in an air supply source of the air cylinder falls below a proper range, the predetermined operation of the valve cannot be expected. Alternatively, when at least one of the fuel valve 25 or the purge gas valve 47 is operated by a motor, if there is an abnormality in an electrical system of the motor, the predetermined operation of the valve cannot be expected. In these cases, the valve normal condition is not satisfied.

### Details of Inspection of Fuel Supply Line 30

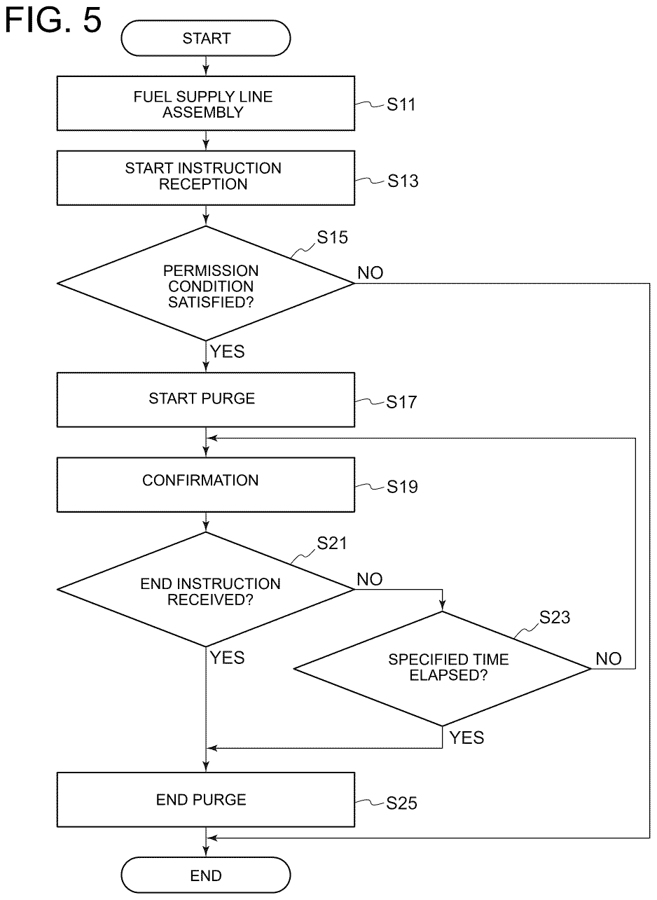

FIG. 5 is a flowchart illustrating an inspection method for the fuel supply line 30 (i.e., the inspection method for a fuel supply line for a gas turbine).

First, a fuel supply line assembly step (S11) in which an assembly worker assembles at least a part of the fuel supply line 30 is executed. For example, when the gas turbine 1 is newly installed, the entire fuel supply line 30 is assembled, while when the gas turbine 1 is periodically inspected, a part of the fuel supply line 30 is assembled.

Next, a start instruction reception step (S13) in which the operation terminal 17 receives a start instruction for a purge gas supply operation is executed. An operator inputs the start instruction to the operation terminal 17 at a desired timing. The processor constituting the control system 15 reads an inspection program for a fuel supply line for a gas turbine from a memory, and automatically starts control processing defined by the program.

The processor executing the control processing executes a determination step (S15) of determining whether the permission condition is satisfied. The processor determines whether the gas turbine stop condition, the operation stop purge condition, the fuel valve closed condition, the vent valve closed condition, the high-pressure purge gas valve closed condition, and the valve normal condition are all satisfied.

When an operation command is not transmitted from the control system 15 to the gas turbine 1, the processor determines that the gas turbine stop condition is satisfied. A command to start up and operate the gas turbine 1 and a command to operate the gas turbine 1 at rated operation both correspond to the operation command.

The processor acquires data indicating the current state of the fuel valve 25 from the fuel valve 25. Further, the processor acquires data indicating the current state of the vent valve 62 from the vent valve 62, and data indicating the current state of the high-pressure purge gas valve 57 from the high-pressure purge gas valve 57. If the acquired data indicates that the fuel valve 25, the vent valve 62, and the high-pressure purge gas valve 57 are in a closed state, the processor determines that the fuel valve closed condition, the vent valve closed condition, and the high-pressure purge gas valve closed condition are all satisfied.

When the fuel valve 25 and the purge gas valve 47 are operated by air cylinders, the processor determines whether the current pressure value in an air supply source falls within a proper range by acquiring data indicating a measurement result of a pressure gauge installed in the air supply source. If the data indicates that the pressure value falls within the proper range, the processor determines that the valve normal condition is satisfied.

When the fuel valve 25 and the purge gas valve 47 are operated by motors, the processor determines whether an error signal is output from an electrical system for driving the motors. The error signal is transmitted when, for example, electric power supplied to the electrical system falls below a specified power value. If the error signal is not output, the processor determines that the valve normal condition is satisfied.

If at least one of the above six conditions is not satisfied, the processor determines that the permission condition is not satisfied (S15: NO). In this case, this inspection ends.

On the other hand, if it determines that the permission condition is satisfied (S15: YES), the processor executes processing for starting the purge gas supply operation (S17). Specifically, the processor sends an open command to the purge gas valve 47, the first supply valve 91, the second supply valves 92, the pilot fuel valve 28, and the main fuel valves 27. Also, the processor sends a close command to the high-pressure purge gas valve 57, the vent valve 62, and the fuel valve 25. Thus, the purge gas supply operation of the gas turbine 1 is automatically started.

Next, a confirmation step (S19) in which an inspector confirms whether there is a leak of the purge gas from the fuel supply line 30 is executed. The inspector walks along the fuel supply line 30 and confirms whether a leak of the purge gas is occurring at each of the plurality of pipe connection parts 35 constituting the pilot fuel supply line 38 or the main fuel supply line 37.

The inspector may confirm the presence or absence of a leak of the purge gas through the sense of touch or the sense of hearing. That is, the inspector may confirm the presence or absence of a leak of the purge gas through the sense of touch by holding the hand near the pipe connection part 35, or may confirm the presence or absence of a leak through the sense of hearing by listening carefully near the pipe connection part 35.

Next, the processor determines whether the operation terminal 17 has received an end instruction for the purge gas supply operation (S21). If the operator has not input the end instruction to the operation terminal 17 (S21: NO), the processor determines whether a specified time has elapsed since the start instruction for the purge gas supply operation was input (S23). The specified time is a time sufficient for the inspector to confirm the presence or absence of a leak of the purge gas, and is a preset time. The specified time is, for example, 30 minutes or 1 hour. If the specified time has not elapsed (S23: NO), the flow of inspection returns to S19.

While S19, S21, and S23 are repeated, the inspector inspects all target pipe connection parts 35. When the inspector inputs the end instruction to the operation terminal 17 (S21: YES), the processor executes processing for automatically ending the purge gas supply operation (S25). Specifically, the processor sends a close command to the purge gas valve 47, the first supply valve 91, the second supply valves 92, the pilot fuel valve 28, and the main fuel valves 27. Thus, the purge gas supply operation ends.

If the inspector who has finished the inspection forgets to input the end instruction to the operation terminal 17 (S21: NO), the specified time elapses (S23: YES). In this case, even if the end instruction is not input to the operation terminal 17, the processor forcibly ends the purge gas supply operation (S25). After S25, this inspection ends.

According to the above configuration, the purge gas supply operation is executed between S17 and S25. If there is an abnormality in assembly in any of the plurality of pipe connection parts 35 constituting the pilot fuel supply line 38 or the main fuel supply line 37, the purge gas leaks from the pipe connection part 35 during execution of the purge gas supply operation. Since the pipe connection part 35 can be inspected through confirmation of the presence or absence of a leak of the purge gas, even an inspector with little experience can easily inspect the assembled state of the fuel supply line 30.

Further, the purge gas supply operation is automatically started only by the operator inputting the start instruction to the operation terminal 17 (S17). Since the operation for starting the purge gas supply operation can be simplified, even an operator with little experience can easily start the purge gas supply operation.

Further, the purge gas supply operation is automatically ended only by the operator inputting the end instruction for the purge gas supply operation to the operation terminal 17 (S21: YES) (S25). Since the operation for ending the purge gas supply operation can be simplified, even an operator with little experience can easily end the purge gas supply operation.

Further, when the specified time elapses after the start instruction is input to the operation terminal 17 (S23: YES), the purge gas supply operation is forcibly ended regardless of whether the operator has input the end instruction to the operation terminal 17 (S25). With this configuration, even when the operator forgets to end the purge gas supply operation, since the purge gas supply operation is forcibly ended, it is possible to prevent a state where the purge gas supply operation is being executed from being left unattended.

Further, with the configuration in which the purge gas supply operation is started only when the permission condition is satisfied, the purge gas supply operation is started when equipment constituting the gas turbine 1 such as valves, actuators of valves, or electrical systems is normal. Thus, it is possible to avoid the purge gas supply operation being started in a situation where an abnormality other than an abnormality in assembly of the pipe connection part 35 exists. Therefore, it is possible to accurately inspect whether there is an abnormality in the assembled state of the pipe connection part 35 when the purge gas supply operation is performed.

Further, with the configuration in which the permission condition includes the gas turbine stop condition and the operation stop purge condition, it is possible to avoid the purge gas supply operation being started during operation of the gas turbine 1 or during execution of a normal purge operation. Thus, it is possible to avoid the purge gas flowing through an unexpected pipe during execution of the purge gas supply operation.

Further, with the configuration in which the permission condition includes the fuel valve closed condition, the vent valve closed condition, and the high-pressure purge gas valve closed condition, it is possible to avoid the purge gas supply operation being started when at least one of the fuel valve 25, the vent valve 62, or the high-pressure purge gas valve 57 is in an open state. Thus, it is possible to avoid the purge gas flowing through an unexpected pipe during execution of the purge gas supply operation.

Further, with the configuration in which the permission condition includes the valve normal condition, the purge gas supply operation is not started when the fuel valve 25 and the purge gas valve 47 are not in a normal state. Thus, it is possible to avoid the purge gas flowing through an unexpected pipe during execution of the purge gas supply operation.

Further, in the confirmation step (S19), the inspector confirms the presence or absence of a leak of the purge gas through the sense of touch or the sense of hearing. With this configuration, since the inspector can intuitively judge the presence or absence of a leak, the assembled state of the fuel supply line 30 can be easily inspected.

### Additional Components of Gas Turbine 1

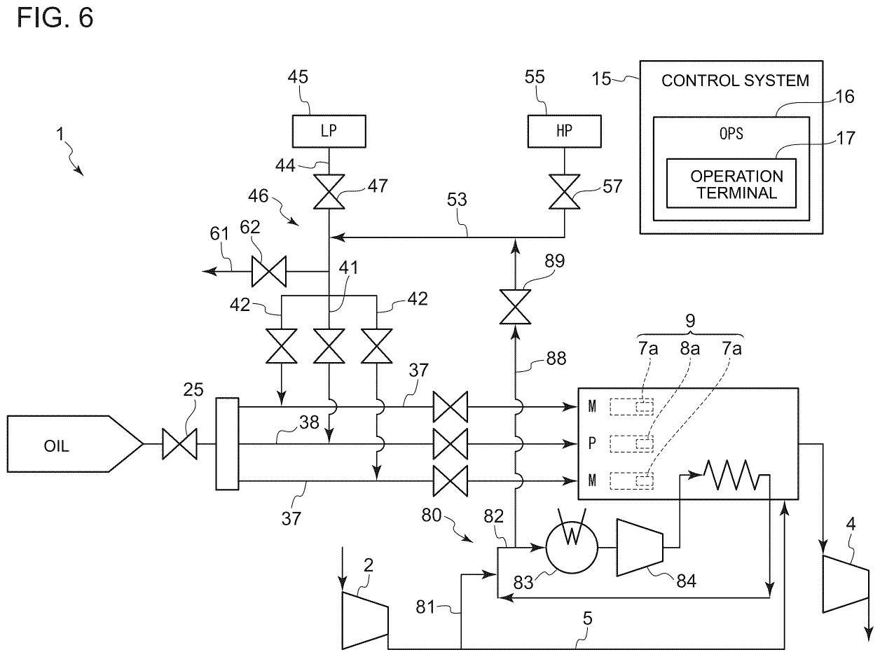

With reference to FIG. 6, additional components that the gas turbine 1 may include will be described. The gas turbine 1 may further include a combustor cooling system 80.

The combustor cooling system 80 includes a compressed air bleed line 81 for bleeding compressed air from the compressed air supply line 5, and a cooling air circulation line 82 for circulating the bled compressed air as cooling air for the combustor 3. A cooler 83 and a cooling air compressor 84 are arranged in this order from the upstream side in the cooling air circulation line 82. The cooler 83 is configured to cool the cooling air. The cooling air compressor 84 is configured to send the cooling air discharged from the cooler 83 to the combustor 3. The cooling air that has cooled the combustor 3 flows through the cooling air circulation line 82 and returns to the cooler 83.

The gas turbine 1 may further include a high-pressure purge gas bleed line 88 for guiding the cooling air bled from the cooling air circulation line 82 to the fuel supply line 30 as the high-pressure purge gas, and a bleed valve 89 disposed on the high-pressure purge gas bleed line 88. The high-pressure purge gas bleed line 88 is connected to the high-pressure purge gas line 53. The cooling air bled by the high-pressure purge gas bleed line 88 may be utilized for the above-described fuel switching purge operation of the gas turbine 1. In this case, the cooling air bled by the high-pressure purge gas bleed line 88 is supplied to the injection nozzle 9 as the high-pressure purge gas.

The permission condition may further include a bleed valve closed condition. The bleed valve closed condition is satisfied when the bleed valve 89 is in a closed state, and is not satisfied when the bleed valve 89 is in an open state. In this case, in the determination step (S15) of determining whether the permission condition is satisfied, if data sent from the bleed valve 89 to the processor indicates that the bleed valve 89 is in the closed state, the processor determines that the bleed valve closed condition is satisfied.

With the above configuration, it is possible to avoid the purge gas supply operation being started when the bleed valve 89 is in the open state. Thus, it is possible to avoid the purge gas flowing through an unexpected pipe during execution of the purge gas supply operation.

### Another Embodiment

The gas turbine 1 may be a single fuel type in which only one type of gas turbine fuel is supplied to the combustor 3. In this case, the gas turbine 1 does not have to include the gas fuel supply system 10. When the gas fuel supply system 10 is not provided, the gas turbine fuel supplied by the fuel supply system 20 may be gas fuel, hydrogen fuel, or ammonia fuel. Further, the hydrogen fuel and the ammonia fuel may be either gaseous or liquid.

In the gas turbine 1 shown in FIG. 6, the air cooling method utilizing compressed air for cooling the combustor 3 is adopted, but the present disclosure is not limited thereto, and the steam cooling method utilizing steam for cooling the combustor 3 may be adopted. For example, the gas turbine 1 may further include a heat recovery steam generator (HRSG) configured to generate steam using exhaust gas discharged from the turbine 4 as a heat source. In this case, the steam generated by the heat recovery steam generator is supplied to the combustor 3.

The present disclosure is not limited to the permission condition including all of the gas turbine stop condition, the operation stop purge condition, the fuel valve closed condition, the vent valve closed condition, the high-pressure purge gas valve closed condition, the valve normal condition, and the bleed valve closed condition. It is sufficient if at least one of these seven conditions is included in the permission condition, or another condition may be included in the permission condition instead of these seven conditions.

In the confirmation step (S19), the inspector may confirm the presence or absence of a leak of the purge gas based on vision. Specifically, when soapy water is applied to the pipe connection part 35, bubbles are formed at the pipe connection part 35 where a leak is occurring. The inspector may confirm the presence or absence of a leak by confirming the presence or absence of bubbles.

### Conclusion

The contents described in some embodiments described above would be understood as follows, for instance.

1) An inspection method for a fuel supply line for a gas turbine according to at least one embodiment of the present disclosure is an inspection method for a fuel supply line for a gas turbine for inspecting the assembled state of the fuel supply line (30) for guiding fuel to a combustor (3) of the gas turbine (1), the method including:
a purge step (S17, S25) of, after assembly of the fuel supply line, continuously supplying a purge gas to the fuel supply line for a predetermined time so that the purge gas is discharged from an injection nozzle (9) of the combustor.

With the above configuration 1), if there is an abnormality in assembly in any of a plurality of pipe connection parts constituting the fuel supply line, the purge gas leaks from the pipe connection part with the abnormality during execution of the purge step. Since the pipe connection part can be inspected through confirmation of the presence or absence of a leak of the purge gas, even an inspector with little experience can easily inspect the assembled state of the fuel supply line.

2) In some embodiments, in the inspection method for a fuel supply line for a gas turbine as defined in the above 1), the purge step is automatically started when an operator inputs a start instruction for the purge step to an operation terminal (17) of a control system (15) of the gas turbine.

With the above configuration 2), the purge step is automatically started only by the operator inputting the start instruction to the operation terminal. Since the operation for starting the purge step can be simplified, even an operator with little experience can easily start the purge step.

3) In some embodiments, in the inspection method for a fuel supply line for a gas turbine as defined in the above 2), the purge step is automatically ended when the operator inputs an end instruction for the purge step to the operation terminal.

With the above configuration 3), the purge step is automatically ended only by the operator inputting the end instruction for the purge step to the operation terminal. Since the operation for ending the purge step can be simplified, even an operator with little experience can easily end the purge step.

4) In some embodiments, in the inspection method for a fuel supply line for a gas turbine as defined in the above 2) or 3), the purge step is forcibly ended when a specified time has elapsed after the start instruction is input to the operation terminal.

With the above configuration 4), even when the operator forgets to end the purge step, the purge step is forcibly ended after the lapse of the specified time. Therefore, it is possible to prevent a state where the purge step is being executed from being left unattended.

5) In some embodiments, the inspection method for a fuel supply line for a gas turbine as defined in any one of the above 1) to 4) further includes a determination step (S15) of, after assembly of the fuel supply line, determining whether a permission condition, under which the purge step is considered to be executable normally, is satisfied.

The purge step is started when the permission condition is satisfied.

With the above configuration 5), the purge step is started when components constituting the gas turbine such as valves, actuators of valves, or electrical systems are normal. Thus, it is possible to avoid the purge step being started in a situation where an abnormality other than an abnormality in assembly of the pipe connection part exists. Therefore, it is possible to accurately inspect whether there is an abnormality in the assembled state of the pipe connection part when the purge step is performed.

6) In some embodiments, in the inspection method for a fuel supply line for a gas turbine as defined in the above 5), the permission condition includes at least one of:
a gas turbine stop condition where the gas turbine is in a stop state; or
an operation stop purge condition where a shutdown purge operation, which automatically supplies the purge gas to the fuel supply line in response to the gas turbine switching from an operation state to the stop state, is not being executed.

With the above configuration 6), it is possible to avoid the purge step being started during operation of the gas turbine or during execution of a normal purge operation. Thus, it is possible to avoid the purge gas flowing through an unexpected pipe during execution of the purge step.

7) In some embodiments, in the inspection method for a fuel supply line for a gas turbine as defined in the above 5) or 6), the gas turbine includes:
a fuel valve (25) disposed on the fuel supply line;
a vent line (61) for guiding a fluid in the fuel supply line to outside; and
a vent valve (62) disposed on the vent line.

The permission condition includes at least one of:
a fuel valve closed condition where the fuel valve is in a closed state; or
a vent valve closed condition where the vent valve is in a closed state.

With the above configuration 7), it is possible to avoid the purge step being started when at least one of the fuel valve or the vent valve is in an open state. Thus, it is possible to avoid the purge gas flowing through an unexpected pipe during execution of the purge step.

8) In some embodiments, in the inspection method for a fuel supply line for a gas turbine as defined in any one of the above 5) to 7), the gas turbine includes:
a low-pressure purge gas supply source (45) for supplying the purge gas to the fuel supply line during execution of the purge step;
a high-pressure purge gas supply source (55) for supplying a high-pressure purge gas with a higher pressure than a pressure of the purge gas to the fuel supply line;
a high-pressure purge gas line (53) connected to the high-pressure purge gas supply source and the fuel supply line; and
a high-pressure purge gas valve (57) disposed on the high-pressure purge gas line.

The permission condition includes a high-pressure purge gas valve closed condition where the high-pressure purge gas valve is in a closed state.

With the above configuration 8), it is possible to avoid the purge step being started when the high-pressure purge gas valve is in an open state. Thus, it is possible to avoid the purge gas flowing through an unexpected pipe during execution of the purge step.

9) In some embodiments, in the inspection method for a fuel supply line for a gas turbine as defined in the above 5) or 8), the gas turbine includes:
a compressor (2);
a compressed air supply line (5) for guiding compressed air sent from the compressor to the combustor;
a cooling air circulation line (82) for circulating the compressed air bled from the compressed air supply line as cooling air for the combustor;
a high-pressure purge gas bleed line (88) for guiding the cooling air bled from the cooling air circulation line to the fuel supply line as a high-pressure purge gas with a higher pressure than the purge gas; and
a bleed valve (89) disposed on the high-pressure purge gas bleed line.

The permission condition includes a bleed valve closed condition where the bleed valve is in a closed state.

With the above configuration 9), it is possible to avoid the purge step being started when the bleed valve is in an open state. Thus, it is possible to avoid the purge gas flowing through an unexpected pipe during execution of the purge step.

10) In some embodiments, in the inspection method for a fuel supply line for a gas turbine as defined in any one of the above 5) to 9), the gas turbine includes:
a purge gas line (46) for guiding the purge gas to the fuel supply line;
a purge gas valve (47) disposed on the purge gas line; and
a fuel valve (25) disposed on the fuel supply line.

The condition includes a valve normal condition where both the fuel valve and the purge gas valve are in a normal state.

With the above configuration 10), the purge step is not started when the fuel valve and the purge gas valve are not in a normal state. Thus, it is possible to avoid the purge gas flowing through an unexpected pipe during execution of the purge step.

11) In some embodiments, the inspection method for a fuel supply line for a gas turbine as defined in any one of the above 1) to 10) further includes a confirmation step (S19) of, during execution of the purge step, confirming a leak of the purge gas from the fuel supply line through the sense of touch or the sense of hearing of an inspector.

With the above configuration 11), the inspector confirms the presence or absence of a leak of the purge gas based on his/her own senses in the vicinity of the pipe connection part. More specifically, the inspector confirms the presence or absence of a leak of the purge gas by holding the hand over the pipe connection part or by listening carefully at the pipe connection part. Since the inspector can intuitively judge the presence or absence of a leak, the assembled state of the fuel supply line can be easily inspected.

12) An inspection program for a fuel supply line for a gas turbine according to at least one embodiment of the present disclosure causes a computer device for inspecting an assembled state of a fuel supply line (30) for guiding fuel to a combustor (3) of a gas turbine (1) to execute:
a purge step (S17, S25) of, after assembly of the fuel supply line, continuously supplying a purge gas to the fuel supply line for a predetermined time so that the purge gas is discharged from an injection nozzle (9) of the combustor.

With the above configuration 12), the same technical advantages as in the above 1) are achieved.

1. An inspection method for a fuel supply line for a gas turbine, for inspecting an assembled state of the fuel supply line for guiding fuel to a combustor of the gas turbine, the method comprising:
a purge step of, after assembly of the fuel supply line, continuously supplying a purge gas to the fuel supply line for a predetermined time so that the purge gas is discharged from an injection nozzle of the combustor.

2. The inspection method for a fuel supply line for a gas turbine according to claim 1,
wherein the purge step is automatically started when an operator inputs a start instruction for the purge step to an operation terminal of a control system of the gas turbine.

3. The inspection method for a fuel supply line for a gas turbine according to claim 2,
wherein the purge step is automatically ended when the operator inputs an end instruction for the purge step to the operation terminal.

4. The inspection method for a fuel supply line for a gas turbine according to claim 2,
wherein the purge step is forcibly ended when a specified time has elapsed after the start instruction is input to the operation terminal.

5. The inspection method for a fuel supply line for a gas turbine according to claim 1, further comprising a determination step of, after assembly of the fuel supply line, determining whether a permission condition, under which the purge step is considered to be executable normally, is satisfied,
wherein the purge step is started when the permission condition is satisfied.

6. The inspection method for a fuel supply line for a gas turbine according to claim 5,
wherein the permission condition includes at least one of:
a gas turbine stop condition where the gas turbine is in a stop state; or
an operation stop purge condition where a shutdown purge operation, which automatically supplies the purge gas to the fuel supply line in response to the gas turbine switching from an operation state to the stop state, is not being executed.

7. The inspection method for a fuel supply line for a gas turbine according to claim 5,
wherein the gas turbine includes:
a fuel valve disposed on the fuel supply line;
a vent line for guiding a fluid in the fuel supply line to outside; and
a vent valve disposed on the vent line, and
wherein the permission condition includes at least one of:
a fuel valve closed condition where the fuel valve is in a closed state; or
a vent valve closed condition where the vent valve is in a closed state.

8. The inspection method for a fuel supply line for a gas turbine according to claim 5,
wherein the gas turbine includes:
a low-pressure purge gas supply source for supplying the purge gas to the fuel supply line during execution of the purge step;
a high-pressure purge gas supply source for supplying a high-pressure purge gas with a higher pressure than a pressure of the purge gas to the fuel supply line;
a high-pressure purge gas line connected to the high-pressure purge gas supply source and the fuel supply line; and
a high-pressure purge gas valve disposed on the high-pressure purge gas line, and
wherein the permission condition includes a high-pressure purge gas valve closed condition where the high-pressure purge gas valve is in a closed state.

9. The inspection method for a fuel supply line for a gas turbine according to claim 5,
wherein the gas turbine includes:
a compressor;
a compressed air supply line for guiding compressed air sent from the compressor to the combustor;
a cooling air circulation line for circulating the compressed air bled from the compressed air supply line as cooling air for the combustor;
a high-pressure purge gas bleed line for guiding the cooling air bled from the cooling air circulation line to the fuel supply line as a high-pressure purge gas with a higher pressure than the purge gas; and
a bleed valve disposed on the high-pressure purge gas bleed line, and
wherein the permission condition includes a bleed valve closed condition where the bleed valve is in a closed state.

10. The inspection method for a fuel supply line for a gas turbine according to claim 5,
wherein the gas turbine includes:
a purge gas line for guiding the purge gas to the fuel supply line;
a purge gas valve disposed on the purge gas line; and
a fuel valve disposed on the fuel supply line, and
wherein the permission condition includes a valve normal condition where both the fuel valve and the purge gas valve are in a normal state.

11. The inspection method for a fuel supply line for a gas turbine according to claim 1, further comprising:
a confirmation step of, during execution of the purge step, confirming leak of the purge gas from the fuel supply line through a sense of touch or a sense of hearing of an inspector.

12. A non-transitory computer-readable medium that stores instructions for causing a processor of a computer device for inspecting an assembled state of a fuel supply line for guiding fuel to a combustor of a gas turbine to execute:
a purge step of, after assembly of the fuel supply line, continuously supplying a purge gas to the fuel supply line for a predetermined time so that the purge gas is discharged from an injection nozzle of the combustor.
